(19) United States
(12) Patent Application Publication
(10) Pub. No.: US 2014/0089957 A1
(43) Pub. Date: Mar. 27, 2014

(54) DYNAMIC ALLOCATION OF ADVERTISING

(71) Applicants: Basil Badawiyeh, Santa Clarita, CA (US); Seth Skolnik, Los Angeles, CA (US)

(72) Inventors: Basil Badawiyeh, Santa Clarita, CA (US); Seth Skolnik, Los Angeles, CA (US)

(73) Assignee: THOMSON LICENSING, Issy de Moulineaux (FR)

(21) Appl. No.: 14/112,611

(22) PCT Filed: Jan. 19, 2012
(86) PCT No.: PCT/US12/21793

§ 371 Date: Oct. 18, 2013

Related U.S. Application Data
(60) Provisional application No. 61/482,833, filed on May 5, 2011.

(51) Int. Cl. H04N 21/442; H04N 21/466; H04N 21/81

(52) U.S. Cl. CPC H04N 21/44222; H04N 21/812; H04N 21/4667
USPC 725/14

(57) ABSTRACT

A method, apparatus and system for the dynamic allocation of advertising content includes tracking user interaction with media content and scheduling a presentation of advertising content based on the tracked user interaction. In one instance, tracking user interaction with media content includes at least one of determining a frequency with which a user switches between avail able programming channels and determining a user preference for an advertising content format or advertised products. In a case in which a frequency with which a user switches between available programming channels is tracked, advertising content is scheduled to be presented at a time during which a user is most likely to be viewing a particular channel and as such, to view the advertising content.

This application claims priority from U.S. Provisional Application No. 61/482,833 filed May 5, 2011.

### FIELD OF THE INVENTION

The present invention generally relates to advertising and, more particularly, to the dynamic allocation of advertising.

### BACKGROUND OF THE INVENTION

In advertising, conventional ad avails (breaks) in content are statically scheduled/set a preset times. For example, broadcast media ad avails are typically set at every 8 minutes, every 15 minutes or the like, depending on the programming.

However, these preset times for ad avails are based on the assumption that a viewer will be interested in continuing to view a program after viewing the programming for a predetermined amount of time (e.g., 30 minutes) and will not change a current channel being viewed. Such an assumption is not always correct in the case of broadcast or switched broadcast media viewing and is more likely to be incorrect when a user is consuming content from multiple sources such as broadcast programming, internet-based programming and stored programming such as content stored on storage mediums like DVDs and PVR hard drives and the like. In each case, each source can contain individual ad avails and advertising content.

### SUMMARY OF THE INVENTION

Embodiments of the present invention address the deficiencies of the prior art by providing a method, apparatus and system for dynamic allocation of advertising.

Embodiments of the present invention track a user's media content consumption habits as well as the content being consumed by the user to enable the dynamic allocation of advertising breaks such that the likelihood of advertising content being viewed by the user is increased.

In one embodiment of the present invention, a method of the present invention includes tracking user interaction with media content and scheduling a presentation of advertising content based on the tracked user interaction.

In an alternate embodiment of the present invention, an apparatus of the present invention includes a memory for storing program routines and data and a processor for executing the program routines. The processor, when executing the program routines, is configured to perform the steps of tracking user interaction with media content and scheduling a presentation of advertising content based on the tracked user interaction.

In an alternate embodiment of the present invention, a system for dynamic allocation of advertising content includes at least one content source for providing media content and an apparatus including a memory for storing program routines and data, and a processor for executing the program routines and a display for displaying at least one of the media content and the advertising content. The processor, when executing the program routines is configured to perform the steps of tracking user interaction with media content and scheduling a presentation of advertising content based on the tracked user interaction.

### BRIEF DESCRIPTION OF THE DRAWINGS

The teachings of the present invention can be readily understood by considering the following detailed description in conjunction with the accompanying drawings, in which:

FIG. 1 depicts a timing diagram for advertisement insertion during programming in accordance with the prior art; and

FIG. 2 depicts a timing diagram for advertisement insertion during programming in accordance with an embodiment of the present invention; and

FIG. 3 depicts a high level block diagram of a content distribution system in which an embodiment of the present invention can be applied;

FIG. 4 depicts a high-level block diagram of a controller of the present invention in accordance with an embodiment of the present invention; and

FIG. 5 depicts a flow diagram of a method for the dynamic allocation of advertising content in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

Embodiments of the present invention advantageously provide a method, apparatus and system for dynamic allocation of advertising. Although the present invention will be described primarily within the context of a content provider providing content for a home network environment, the specific embodiments of the present invention should not be treated as limiting the scope of the invention. It will be appreciated by those skilled in the art and informed by the teachings of the present invention that the concepts of the present invention can be advantageously applied to any content distribution or communications environment in which it is desirable to distribute advertising content.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

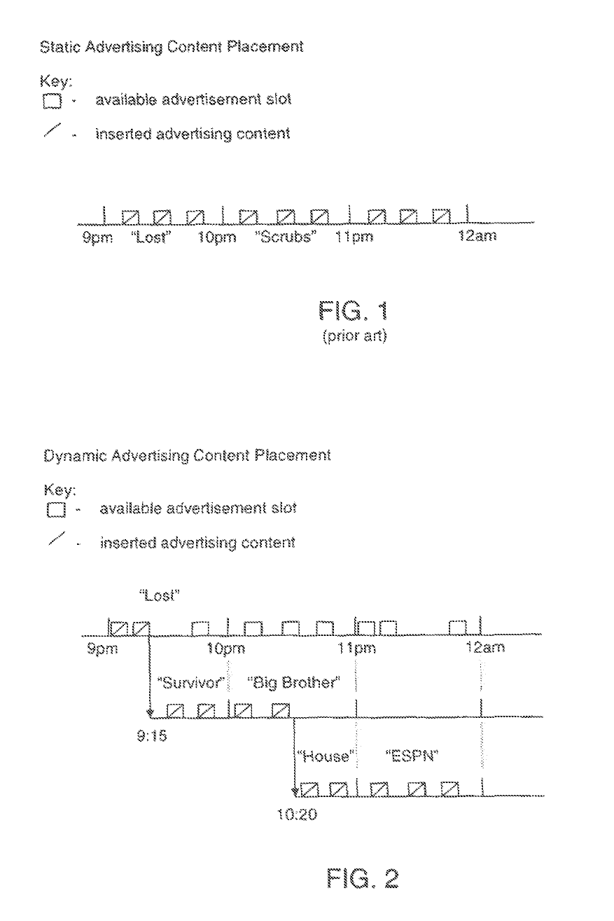

In one embodiment of the present invention, a user's interaction with media content is tracked and such information is used to schedule advertising such that the advertising is likely to be viewed by the user. For example, if a user switches between programming content (i.e., switches channels) every 15 minutes, advertising breaks can be intelligibly distributed in a manner that increases the chances of such advertising being viewed by the user. For example, FIG. 1 depicts a timing diagram for advertisement insertion during programming in accordance with the prior art. As depicted in FIG. 1, advertising breaks (ad avails) are periodically scheduled (e.g., every 15 minutes) according to a static viewing timeline. For example, as depicted in FIG. 1, advertising content is scheduled to be presented every 15 minutes between 9 pm-10 pm during the presentation of the program “Lost”. In addition and as depicted in FIG. 1, advertising content is scheduled to be presented every 15 minutes between 10 pm-11 pm during the presentation of the program “Scrubs”. Similar advertising breaks are scheduled within the hour of 11 pm-12 pm in FIG. 1.

In accordance with various embodiments of the present invention, a user's viewing schedule can be used to determine an ideal time for scheduling advertising breaks in content for that viewer. For example, if it is determined that a user, on a specific date and time (e.g., Tuesdays at 8 pm), only views the first 15 minutes of a 30 minute program, advertising breaks can be scheduled during the first 15 minutes of the program. In another example, if it is determined that a user typically records a program on a specific date and time (e.g., Friday at 9 pm) and then consumes the recorded program by fast forwarding to view a specific portion of the recorded program (e.g., the last 10 minutes of the program), advertising breaks for future presentations of that program to be recorded can be scheduled to be concentrated to be presented around the specific portion of the program most likely to be viewed (e.g., the last 10 minutes of the program).

That is, instead of scheduling advertising breaks periodically, for example every 15 minutes as is typical in a prior art system such as the prior art system of FIG. 1, in an embodiment of the present invention, advertising content is scheduled to be presented based on user interaction with media content/scheduled programming. For example, FIG. 2 depicts a timing diagram for dynamic advertisement insertion during programming in accordance with an embodiment of the present invention. As depicted in FIG. 2, advertising breaks are scheduled dynamically in “user time” and in response to user behavior as described herein. In FIG. 2, it is assumed that a user has exhibited the following behavior. A user typically watches the first 15 minutes of “Lost” at 9 pm on a first programming channel and then switches to an alternate programming channel for watching the remaining portion of “Survivor” from 9:15 pm until 10 pm. The user then typically remains on the same programming channel and watches the “Big Brother” from 10 pm until 10:20 pm. The user then switches to an alternate programming channel and watches the remaining portion of “House” from 10:20 until 11 pm and remains on the same programming channel for watching “ESPN” from 11 pm-12 am.

In accordance with the depicted embodiment of the present invention of FIG. 2, having knowledge of the user's previous behavior by, for example tracking the user's previous interactions with media content, a method, apparatus and system of the present invention schedules the presentation of advertising content at times during which the user is most likely to view the advertising content. For example, in the embodiment of FIG. 2, advertising content is scheduled to be presented during the first 15 minutes of “Lost” during which the user has exhibited a likelihood to be viewing. That is, in the embodiment of FIG. 2, advertising content can be scheduled to be presented after the first 5 minutes, 3 minutes after that and then 5 minutes after that to optimize the likelihood that advertising content is viewed within the first 15 minute period of “Lost”. As depicted in FIG. 2, however, advertising breaks can be scheduled to be presented at various times within the programming on the same programming channel for an extended period of time in the event that the user does not follow his typical behavior and remains on the same programming channel.

Referring back to the embodiment of FIG. 2, when it is determined that a user has switched a programming channel to now view “Survivor”, advertising content can be scheduled to be presented throughout the remaining portion of the program “Survivor” having past behavioral evidence that the user will remain on that programming channel to watch the remaining portion of “Survivor”.

As depicted in the embodiment of FIG. 2, advertising content is scheduled to be presented during the first 20 minutes of “Big Brother” between the hours of 10 pm and 10:20 pm, a time during which the user has exhibited a likelihood to be viewing. Again, when it is determined that a user has switched a programming channel at 10:20 pm to now view “House”, advertising content can be scheduled to be presented throughout the remaining portion of the program “House” having past behavioral evidence that the user will remain on that programming channel to watch the remaining portion of “House”. In addition, using previous behavioral evidence, advertising content is scheduled to be presented throughout the program “ESPN” from 11 pm to 12 am, a time during which the user has exhibited a likelihood to be viewing.

Even further, in accordance with various embodiments of the present invention, a user's interaction with a particular type of content can be tracked to determine a most effective means of advertising for a particular user. For example, by presenting various types of advertising platforms, such as a banner ad, video, cartoon, 3D based ad or the like, to a user and tracking how long a user views the advertisement, by for example determining if a user changed to a different channel, a most effective advertising platform for that user can be determined. In addition, in alternate embodiments of the present invention, by presenting various types of products, such as athletic gear, home repair products, food products, etc., to a user and tracking how long a user views the advertisement, by for example determining if a user changed to a different channel, a most effective product type to be advertised to that user can be determined.

In accordance with the concepts of the present invention, because a user's past viewing habits can be used to predict future behavior, advertising breaks can be scheduled such that the advertising is most likely to be viewed and advertising that is most relevant to a user can be presented to the user. As such, a provider, such as a content provider, can charge premiums or higher rates during those times determined to be times during which a user will most likely be viewing a presentation and strategically placed ads in accordance with the concepts of the present invention. That is, for example, a content provider can ensure that higher priced ads (e.g., Pepsi or Nike ads) are scheduled to display during times when a user is most likely to be viewing and that lower priced ads (e.g., local advertising) are scheduled to be displayed during other times.

Even further, in one embodiment of the present invention, a user's viewing preferences can be used to determine a most effective type of advertising to present to a viewer. For example, in one embodiment, if a user is watching a Travel show, travel related advertising can be presented to that user, for example, during a time when the user is most likely to be viewing, determined as described herein.

Along similar lines, a user's channel selection habits can be used to determine when advertising breaks should be scheduled. More specifically, in one embodiment of the present invention, if a user is known to habitually select specific channels during specific periods of viewing time, a decision can be made to selectively present advertising during the viewing of specific channels and to not present advertising during the viewing of other channels. For example, if a user's viewing habits from 8 pm to 9 pm on Wednesday nights indicate that the user watches a program continuously from 8 pm to 8:30 pm on, for example, NBC and switches between CNN, Hulu and YouTube from 8:30 pm to 9 pm, then it can be decided to schedule advertising breaks during determined appropriate timing intervals between 8 pm to 8:30 pm and can schedule advertising breaks between 8:30 pm and 9 pm such that ads are shown during the viewing of content from Hulu and YouTube during which a user should be more receptive to ads and not during the viewing of content on CNN during which a user may not want to be disturbed by ads. In accordance with various embodiments of the present invention, other factors can be used to determine during which programming to schedule advertising breaks. For example, in one embodiment of the present invention, if a user is alternatively or iteratively viewing between pay content and free content, it may be decided to present ads to a user during the viewing of free content and limit or restrict the presentation of ads during the viewing of pay content.

In an alternate embodiment of the present invention, user activity on a secondary/auxiliary screen can be used to determine where and when to present advertising content to the user. For example, in a system in which there exists a main screen for displaying content and a secondary/auxiliary screen for displaying additional content related or unrelated to the main content, the user activity on the secondary/auxiliary screen (i.e., user requesting additional content related to content being displayed in the main screen or user participating social network commenting on main content) can be used to determine where and when to present advertising content to the user. That is, if a user is determined to be active on the secondary/auxiliary screen, the times of the activity on the secondary/auxiliary can be determined to be appropriate times to schedule advertising breaks on the main screen, or alternatively, on the secondary/auxiliary screen because the likelihood is greater that, during these times, the ads will be viewed by the viewer. As described above, in such an embodiment, the subject of the user activity on the secondary/auxiliary screen can be used to determine what type of adverting content presented to the user would be most effective. For example, if the content on the main screen is related to a destination of particular interest for travel (i.e., a scene taking place in Hawaii) and a user requests information on the secondary/auxiliary screen regarding travel or Hawaii, advertising related to travel can be presented to the user. In alternate embodiments of the present invention, such advertising information (i.e., travel information) can be communicated to the user via the secondary/auxiliary screen or the main screen in the form of an advertising break even if, in the example above, the user has not requested information regarding Hawaii or travel.

In accordance with the concepts of the present invention and various embodiments of the present invention, the current position in the playout of content is considered when determining when to schedule advertising breaks. More specifically, in one embodiment of the present invention, appropriate ad insertion points are determined by considering scene changes such as the end or beginning of a scene or other similar breaks in the continuity of content and advertising breaks can be scheduled to play advertising at the onset of such events.

It should be noted that in various embodiments of the present invention, such advertising breaks can be scheduled to appear on one of a main screen and a secondary/auxiliary screen such that a user experience of a main content is not disrupted. In addition, in accordance with the concepts of the present invention, in various embodiments of the present invention, an advertising break can be schedule to appear on a screen as a portion of a screen (i.e., banner ad) instead of appearing on the entire screen. In addition, in various embodiments of the present invention, determined information regarding user preference for a specific type of advertising format, as described above, can be used to present the scheduled advertising break on a portion of the screen in a format most preferred by a user.

In accordance with the concepts of the present invention, some of the factors to consider for determining when and where to schedule advertising breaks during the viewing of content include the content being viewed, how long the content is being viewed, what is the source of the content (i.e., broadcast channel, video on demand, internet streaming source, web page, etc.), user's level of engagement with the content being viewed, user's level of interaction with the content or advertising, does a user view the content live or in a recorded format, whether or not trick play functions are used on the recorded content (i.e., fast forwarding to specific locations in the content), whether the user forwards the content to others, for example, using social network sites and when, and what directed the user to the content (i.e., EPG listing, advertisement, friend recommendation and the like).

FIG. 3 depicts a high level block diagram of a content distribution system in which an embodiment of the present invention can be applied. The content distribution system 100 of FIG. 3 illustratively comprises at least one server 110, a plurality of receiving devices such as tuning/decoding means (illustratively set-top boxes (STBs)) 120₁-120ₙ, and a respective display 130₁-130ₙ for each of the set-top boxes 120₁-120ₙ. Although in the system 100 of FIG. 3, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 3 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

The server 110 of the content distribution system 100 is capable of receiving content (e.g., distribution packs) and, accordingly, distributes the content to the various receivers such as the set-top boxes 120 and displays 130. That is, at the content distribution system 100, content is received and configured for streaming. The streaming can be performed by one or more servers configured to act together or in concert. The streaming content can include content configured for various different locations or displays 130. For example, respective set-top boxes 120 and displays 130 can be located at specific locations throughout a commercial or residential location and respectively configured to display content and broadcast audio pertaining to products located within a predetermined distance from the location of each respective set-top box and display.

In one embodiment of the present invention, the server 110 of the content distribution system 100 receives media content and distributes the media content to the various receivers such as the set-top boxes 120 and displays 130. A controller 150 of the present invention, illustratively located in FIG. 3 in the server 110 of FIG. 3, then monitors/tracks user interaction with media content as described herein. The controller 150 then schedules a presentation of advertising content based on the tracked user interaction as described herein. For example, in one embodiment of the present invention, the controller 150 causes the server 110 to communicate advertising content to a set-top box 120, the advertising content scheduled to be presented at a scheduled time during which a user is most likely to view the advertising content; the scheduled presentation time being determined based on the monitored/tracked user interaction.

Although in the embodiment of FIG. 3, the controller 150 of the present invention is illustratively depicted as an integrated component of the server 110, in alternate embodiments of the present invention, a controller of the present invention can comprise an integrated component of the set-top box 120 or can comprise an integrated component of an upstream server/computer located in, for example, a head-end of a content distribution system. In yet an alternate embodiment of the present, a controller of the present invention can comprise a stand-alone component.

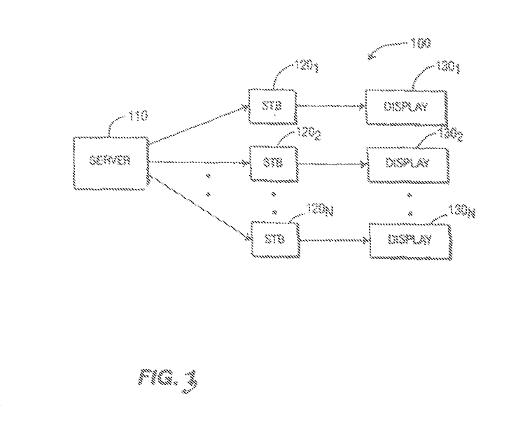

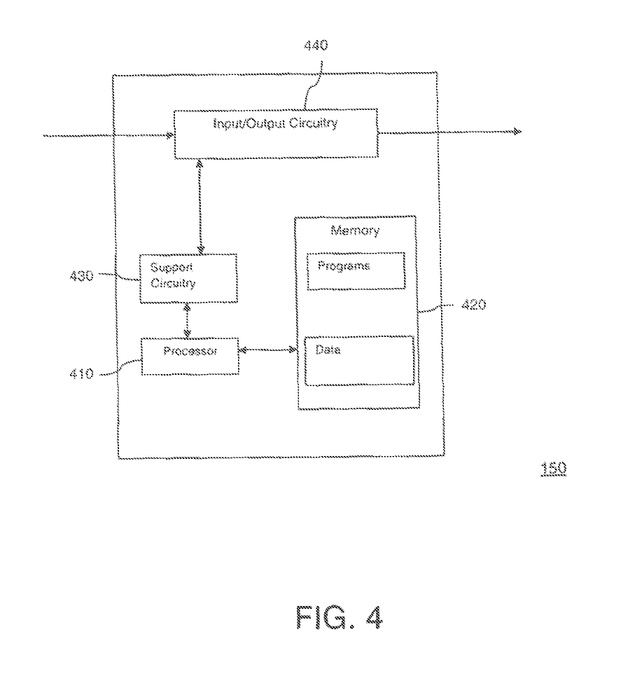

FIG. 4 depicts a high-level block diagram of a controller 150 of the present invention in accordance with an embodiment of the present invention. More specifically, the controller 150 of FIG. 4 illustratively comprises a processor 410 as well as a memory 420 for storing control programs, user interaction history, stored media and the like. The processor 410 cooperates with conventional support circuitry 430 such as power supplies, clock circuits, cache memory and the like as well as circuits that assist in executing the software routines stored in the memory 420. As such, it is contemplated that some of the process steps discussed herein as software processes may be implemented within hardware, for example, as circuitry that cooperates with the processor 410 to perform various steps. The controller 150 also contains input-output circuitry 440 that forms an interface between various functional elements communicating with the controller 150.

Again, although the controller 150 of FIG. 4 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software executed by a processor, hardware, or a combination thereof. In addition, although the controller 150 of FIG. 4 is depicted as capable of being a separate component, the functionalities of the controller 150 in accordance with the concepts and embodiments of the present invention described herein can be incorporated into an existing system component such as a set-top box, personal video recorder, digital video recorder or content provider server and the like.

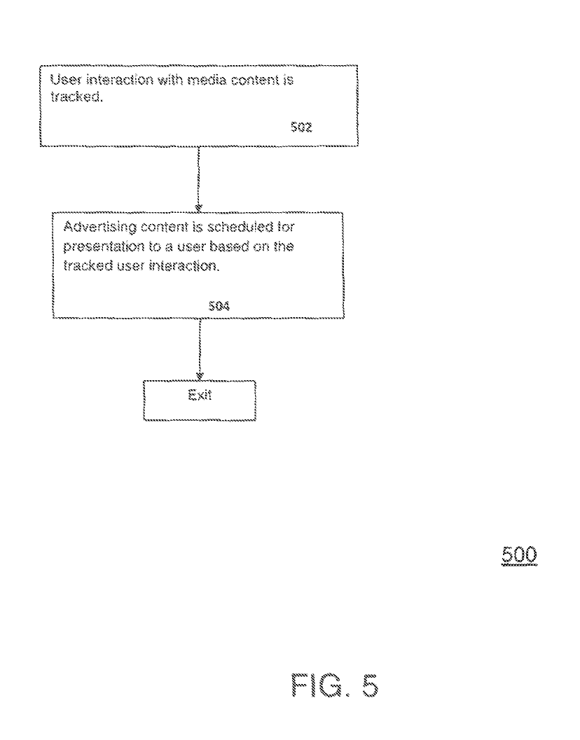

FIG. 5 depicts a flow diagram of a method for the dynamic allocation of advertising content in accordance with an embodiment of the present invention. The method 500 begins at step 502 during which user interaction with media content is tracked. For example and as described above, in one embodiment of the present invention tracking user interaction with media content includes determining a frequency with which a user switches between available programming channels. In alternate embodiments of the present invention tracking user interaction with media content determining advertising content that a user prefers, the user preference determined by tracking advertising content viewed by a user and advertising content skipped by a user. In various embodiment of the present invention, a determined user preference can include a type of product being advertised and/or a type of advertising being used, such as a banner ad, a video, a cartoon and a three-dimensional based advertisement. The method 500 then proceeds to step 504.

At step 504, advertising content is scheduled for presentation to a user based on the tracked user interaction. For example and as described above, in an embodiment in which a frequency with which a user switches between available programming channels is tracked, advertising content is scheduled to be presented at a time during which a user is most likely to be viewing a particular channel and as such, to view the advertising content. The method 500 can then be exited.

Having described various embodiments for a method and means for dynamic allocation of advertising (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method, comprising:
tracking user interaction with media content; and
scheduling a presentation of advertising content based on the tracked user interaction.

2. The method of claim 1, wherein tracking user interaction with media content comprises determining a frequency with which a user switches between available programming channels.

3. The method of claim 2, comprising scheduling the presentation of advertising content at a time during which the user is most likely to be viewing a particular programming channel.

4. The method of claim 1, wherein tracking user interaction with media content comprises determining advertising content that a user prefers.

5. The method of claim 4, comprising tracking advertising content viewed by a user and advertising content skipped by a user to determine a user preference for advertising content.

6. The method of claim 5, wherein a user preference includes a type of product being advertised.

7. The method of claim 5, where a user preference includes a type of advertising platform being used.

8. The method of claim 7, wherein a type of advertising platform being used includes at least one of a banner ad, a video, a cartoon and a three-dimensional based advertisement.

9. The method of claim 1, wherein tracking user interaction with media content comprises identifying user activity on a second, auxiliary display screen.

10. The method of claim 9, comprising scheduling a presentation of advertising content on at least one of the second, auxiliary display screen and a main display screen in response to identified user activity on the second, auxiliary display screen.

11. The method of claim 1, wherein tracking user interaction with media content comprises identifying media content being viewed by a user.

12. The method of claim 11, comprising scheduling a presentation of advertising content related to the identified media content during a presentation time of said identified media content.

13. An apparatus, comprising:
a memory for storing program routines and data; and
a processor for executing said program routines, said processor, when executing said program routines, configured to perform the steps of:
tracking user interaction with media content; and
scheduling a presentation of advertising content based on the tracked user interaction.

14. The apparatus of claim 13, wherein said apparatus comprises a controller.

15. A system for dynamic allocation of advertising content, comprising:
at least one content source for providing media content;
an apparatus including a memory for storing program routines and data, and a processor for executing said program routines, said processor, when executing said program routines, configured to perform the steps of:
tracking user interaction with media content; and
scheduling a presentation of advertising content based on the tracked user interaction; and
a display for displaying at least one of the media content and the advertising content.

16. The system of claim 15, wherein said apparatus comprises a server of a content distribution system.
